(19) United States
(12) Patent Application Publication
(10) Pub. No.: US 2015/0032828 A1
(43) Pub. Date: Jan. 29, 2015

(54) Friendly Names for Stored CPM Conversation Histories

(71) Applicant: BlackBerry Limited, Waterloo (CA)

(72) Inventor: Zoltán Ördögh, Mississauga (CA)

(73) Assignee: BlackBerry Limited, Waterloo (CA)

(21) Appl. No.: 13/952,365

(22) Filed: Jul. 26, 2013

(51) Int. Cl. H04L 12/58

(52) U.S. Cl. CPC H04L 51/00
USPC 709/206

(57) ABSTRACT

A method is provided for providing a meaningful representation for a conversation that occurs according to an OMA CPM protocol. The method comprises generating a friendly name for the conversation, wherein the friendly name comprises a string of characters that form a meaningful expression to a conversation participant, and associating the friendly name with the conversation.

### BACKGROUND

The Open Mobile Affiance (OMA) was formed in June 2002 by nearly 200 companies representing the world's leading mobile operators, device and network suppliers, information technology companies, and content providers. The OMA is designed to be the center of mobile service enabler specification work and to help in the creation of interoperable services that will meet the needs of users across countries, operators, and mobile terminals. To grow the mobile market, the companies supporting the OMA work towards stimulating the fast and wide adoption of a variety of new, enhanced mobile information, communication, and entertainment services.

The OMA was created by consolidating the efforts of the supporters of the Open Mobile Architecture initiative and the Wireless Application Protocol (WAP) Forum. In addition, the Synchronization Markup Language (SyncML) initiative, Location Interoperability Forum (LIF), MMS Interoperability Group (MMS-IOP), Wireless Village, Mobile Gaming Interoperability Forum (MGIF), and Mobile Wireless Internet Forum (MWIF) have consolidated into the OMA. By linking the activities of a number of organizations, the OMA can address areas that previously fell outside the scope of any existing organizations as well as streamline work that previously may have been duplicated by multiple organizations.

The OMA Converged IP (Internet Protocol) Messaging (CPM) working group is working on the CPM 2.0 Enabler, which is intended to bring improvements to the CPM 1.0 standard based on requirements that originate from the Rich Communications Convergence Task Force (RCCTF) working group of the GSMA (GSM (Global System for Mobile Communications) Association) in relation to the Rich Communication Suite (RCS). For further details, the CPM 2.0 Enabler may be found at http://technical.openmobilealliance.org/Technical/release_program/cpm_v2_{—}0.aspx.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a CPM architecture diagram, according to the prior art.

FIG. 2 illustrates the reflection of a CPM conversation as a CPM conversation history, according to the prior art.

FIG. 3 illustrates an example of a default folder storage model of CPM 2.0 message storage, according to the prior art.

FIG. 4 illustrates a portion of the OMA system description specification, according to the prior art.

FIG. 5 illustrates a portion of the OMA conversation function specification, according to the prior art.

FIG. 6 illustrates an example of a generated string according to an embodiment of the disclosure.

FIG. 7 illustrates a hexadecimal representation of a UTF-8 encoded string according to an embodiment of the disclosure.

FIG. 8 illustrates a base-64 encoded UTF-8 sequence according to an embodiment of the disclosure.

FIG. 9 illustrates an example of an attempt to retrieve metadata that does not exist according to an embodiment of the disclosure.

FIG. 10 illustrates an example of storing or updating metadata according to an embodiment of the disclosure.

FIG. 11 illustrates an example of retrieving metadata according to an embodiment of the disclosure.

FIG. 12 is a flowchart illustrating the generation of a friendly name by a participating function according to an embodiment of the disclosure.

FIG. 13 is a flowchart illustrating the generation of a friendly name by a CPM client according to an embodiment of the disclosure.

FIG. 14 is a simplified block diagram of an exemplary network element according to one embodiment.

FIG. 15 is a block diagram with an example user equipment capable of being used with the systems and methods in the embodiments described herein.

FIG. 16 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The OMA CPM standards specify that an identifier known as the Conversation-ID is to be automatically generated for and associated with a CPM conversation in order to uniquely identify each CPM conversation. The same identifier may be used in the message storage as well, when the CPM conversation is finally stored as a CPM conversation history. However, this identifier may be a lengthy string of characters that may be meaningless to a human user. In an embodiment, in addition to the actual Conversation-ID, a representation of the Conversation-ID that is meaningful to a human user may be generated, based on any available information, and the generated representation may be displayed on the user's device, instead of the Conversation-ID. The representation may be characters of a native language of the user, or of a language of the conversation, or any other language recognizable by the user. There may be a number of problems associated with having to generate representations on individual devices. For example, generating the information may consume a significant amount of resources, such as processing power and network bandwidth. As another example, there's no guarantee that two devices—same or different makes of devices—will generate the same representations. From the end-user's point of view, it may be vital that the representation of the conversation persists across each and every device of the end-user for as long as the conversation exists—unless of course, it is deliberately changed by the end-user. Having different representations on different devices for the same conversation may confuse end-users. Still further, participants in the same conversation might want to designate their own custom representations. Such custom representations may be specific to the user and for privacy reasons, should not be exposed to other participants in the same conversation. Embodiments of the present disclosure provide methods and apparatus for the generation of initial user-friendly representations for each stored CPM conversation history, for allowing the user-friendly representations to be customized, and for making these user-friendly representations available for all devices of an end-user, which may eliminate the need to generate a representation on each individual device

As used herein, terms such as “device” or “mobile device” may refer to transportable devices such as mobile telephones, smartphones, personal digital assistants, handheld, tablet, nettop, or laptop computers, a USB device/dangle, and similar devices that have telecommunications capabilities. In other cases, such terms might refer to devices that have similar capabilities but that are not transportable, such as desktop computers, set-top boxes, or network appliances. Such terms can also refer to any hardware or software component that can terminate a communication session for a user. Other possible synonyms for such a device may include mobile station, MS, user equipment, UE, target entity, wireless device, network endpoint target entity, end point, end device, destination, subscriber, user, destination subscriber/user, terminating subscriber user, session initiation protocol (SIP) user agent (UA), or RCS client.

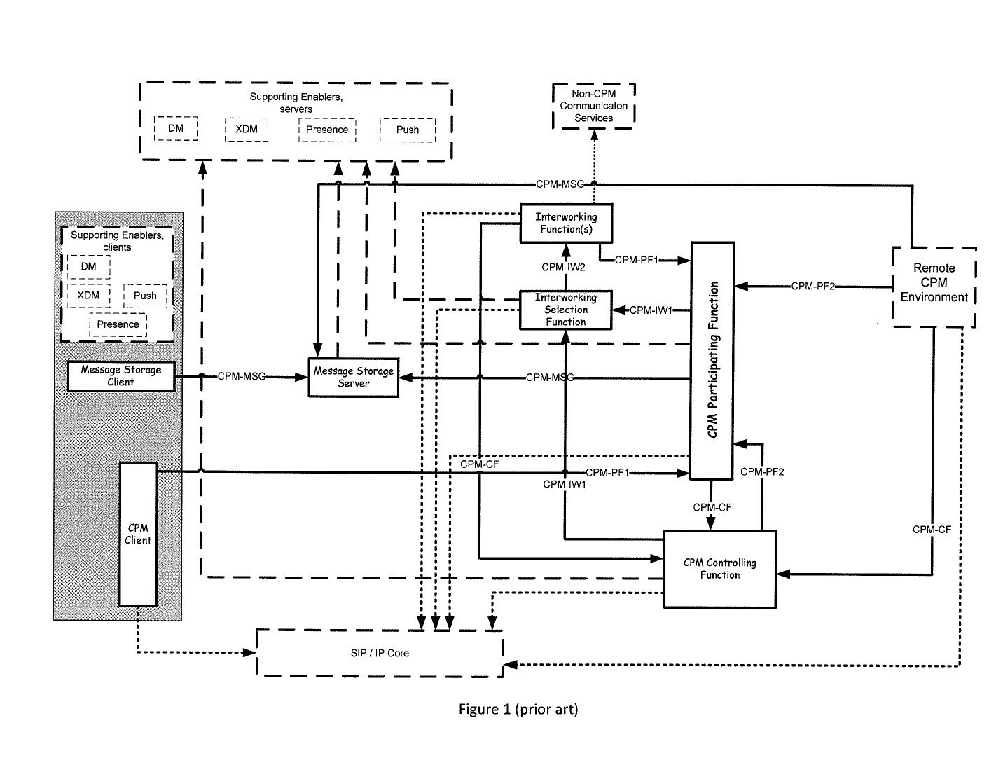

To promote understanding of the embodiments disclosed herein, background information will now be provided regarding the OMA CPM Enabler, specifically regarding the way conversations are reflected in the Message Storage Server. FIG. 1 illustrates the CPM system architecture.

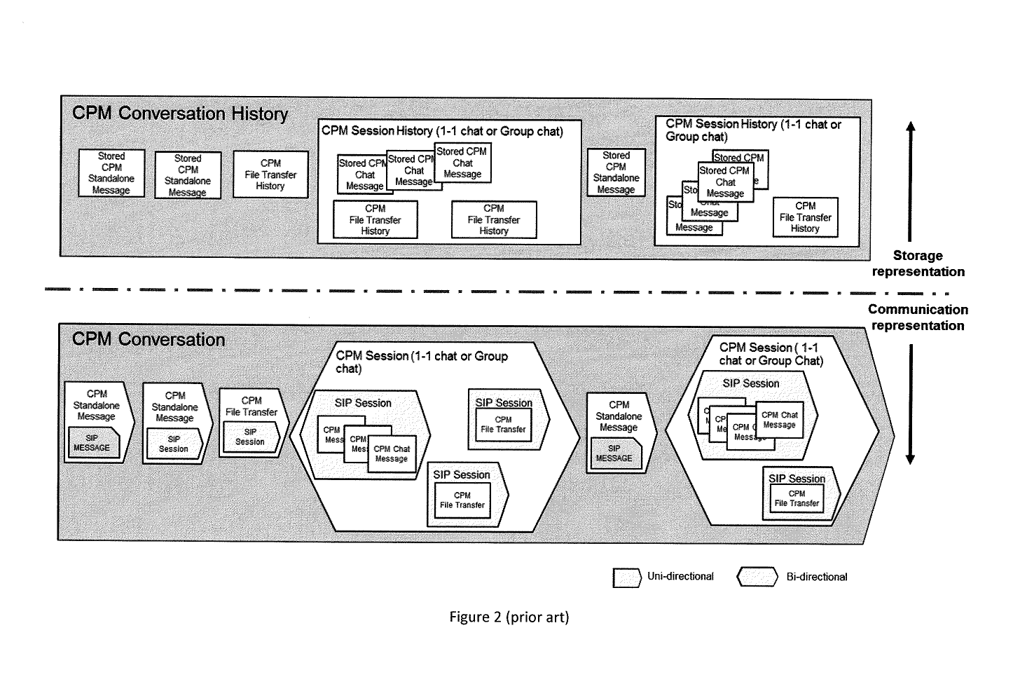

During a chat session, two or more CPM clients typically exchange chat messages and possibly share files such as pictures, video clips, documents, and any discrete media supported by both endpoints. Any such exchange of information may be referred to herein as a conversation. For any CPM user that has a Message Storage Server configured, the CPM Participating Function (see FIG. 1) may record the conversation and store a CPM Conversation History, which reflects the conversation that is currently taking place or that previously took place between the endpoints. A figure in section 4 of OMA CPM, OMA-RD-CPM-V2_{—}0: “Converged IP Messaging Requirements” provides a high-level overview regarding how a CPM conversation is reflected into the Message Storage Server and hence becomes a CPM Conversation History. That figure is provided as FIG. 2 herein for convenience.

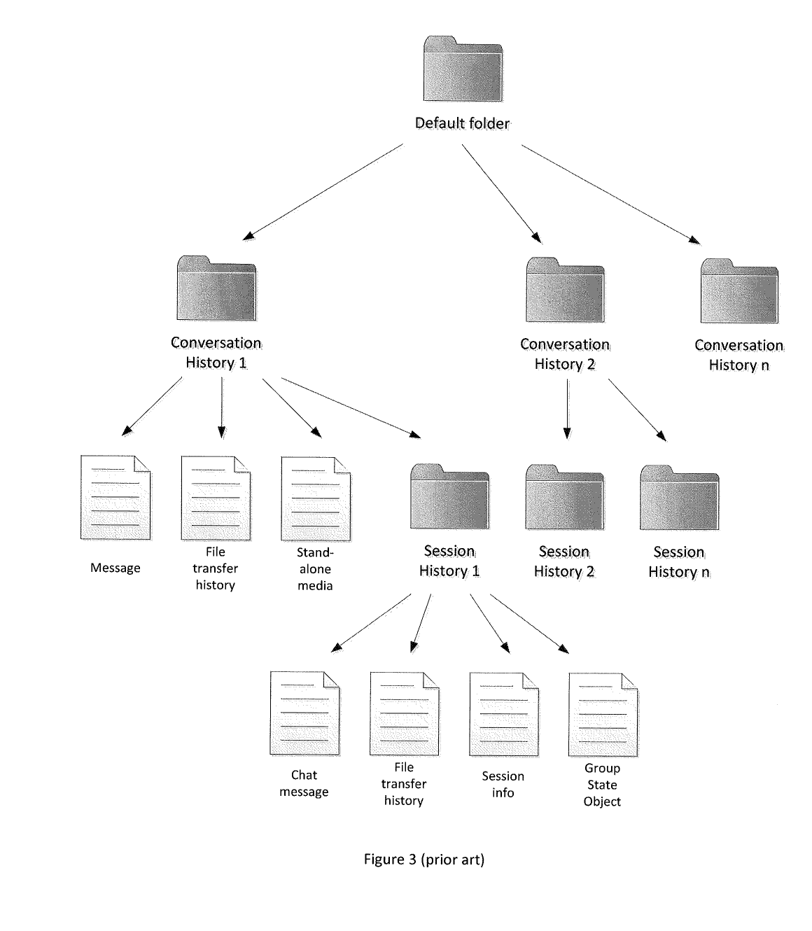

A CPM user may begin as many conversations as the user likes or may continue old conversations as needed. FIG. 3, from OMA CPM, OMA-TS-CPM_System_Description-V2_{—}0: “OMA Converged IP Messaging System Description”, illustrates the storage layout for a stored conversation. The “default folder” is a logical location in the storage that represents the “entry point” for all information recorded. Since the default folder is a logical location, each service provider is able to choose its own location for the folder.

It is the responsibility of the Participating Function (PF) to extract various items from a conversation and store the extracted items, as described in OMA CPM, OMA-TS-CPM_Conversation_Function-V2_{—}0: “CPM Conversation Functions”. The extracted items may include messages, files, and CPM-specific objects, such as session Information objects that contain information about chat sessions; Group State Objects that contain a list of participants that were in a conference at the moment the user left; and identifiers such as the Conversation-ID or the Contribution-ID. These items may be stored into the corresponding Conversation History folder one-by-one, immediately in the case of a live recording, or may be deferred, aggregated, and stored as a whole, after the chat session has concluded. The Conversation-ID is the item with the most relevance to the embodiments disclosed herein.

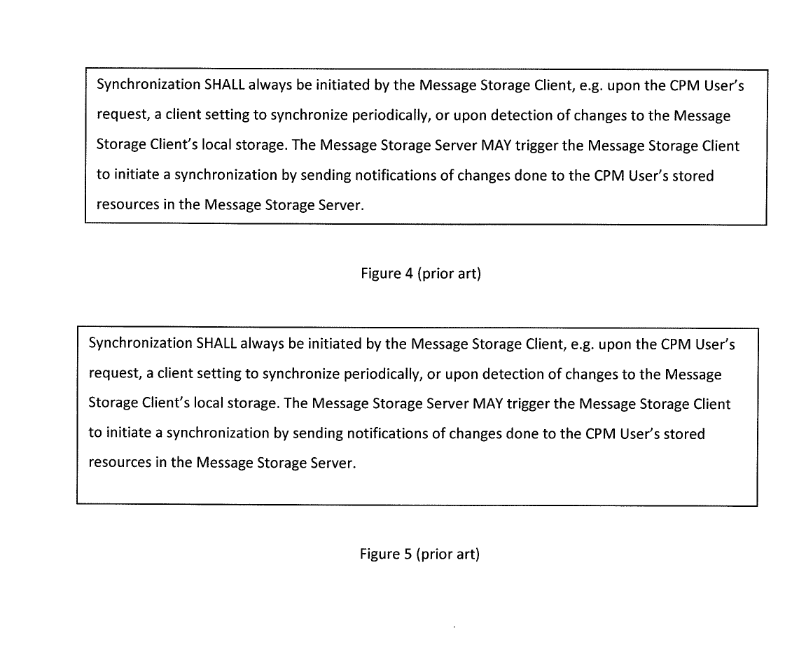

It may be expected that CPM clients will maintain a local repository stored somewhere on a device using a built-in or removable storage medium and that the clients will cache the information stored on the Message Storage Server in order to minimize access times and preserve network bandwidth use. CPM clients maintaining such a local repository may also be expected to keep the local storage synchronized with the remote storage on the Message Storage Server, as described in the last sub-section of section “5.52 Operations” in OMA CPM, OMA-TS-CPM_System_Description-V2_{—}0 and as illustrated in FIG. 4.

Any given CPM conversation is identified using a unique Conversation-ID. That is, there may be one and only one CPM Conversation History folder per CPM conversation. The name of the Conversation History folder is the Conversation-ID itself. The Conversation-ID syntax is defined in Appendix C.1.1 of OMA CPM, OMA-TS-CPM_Conversation_Function-V2_{—}0, and the syntax definition is illustrated in FIG. 5.

The OMA CPM Enabler supports storing metadata for objects and folders, but the term “metadata” is not strictly defined in the OMA CPM specifications. For example, metadata may refer to flags and keywords (as per Internet Engineering Task Force (IETF), Request for Comments (RFC) 3501: “INTERNET MESSAGE ACCESS PROTOCOL—VERSION 4rev1” March 2003), access control lists (as per ETF RFC4314: “IMAP4 Access Control List (ACL) Extension”, December 2005), or server annotations and mailbox annotations (as per IETF, RFC5464: “The IMAP METADATA Extension”, February 2009). The type of OMA CPM metadata with the most relevance to the embodiments disclosed herein is the mailbox annotation defined in RFC5464. Therefore, whenever metadata is mentioned herein, it may be assumed that the mailbox annotation is being referred to, but it may be noted that the word “metadata” may have other meanings. In addition, the words “folder” and “mailbox” may be mutually interchangeable herein.

The OMA CPM standard specifies that the Conversation-ID be used at a protocol level to guarantee interoperability. The Conversation-ID is unique (e.g., “f81d4fae-7dec-11dO-a765-00a0c91e6bf6”) and does ensure the interoperability of the system. However, the Conversation-ID may be meaningless to a CPM user, especially as more and more CPM Conversation Histories are stored over time. That is, if a Conversation-ID such as “f81d4fae-7dec-11d0-a765-00a0c91e6bf6” appears on the user interface of a device, the user of the device may not be able to easily associate such a Conversation-ID with a particular conversation. Consequently, it may be desirable to have a user-friendly representation of the Conversation-ID displayed on the device instead of the actual Conversation-ID.

It may be desirable for such a user-friendly representation to satisfy a number of criteria. First, all of the user's devices should show the same user-friendly representation for the same conversation. That is, if the user changes the user-friendly name of a CPM Conversation History on one device, then the new name should also be used on the other devices of the same user, thus synchronizing the user-friendly name among different devices belonging to the same user. Second, the user may be able to assign a more meaningful use friendly name to a Conversation-ID. Therefore, each participant should be able to change the user-friendly name of a CPM Conversation History in the user's own storage. At this point, the user-friendly name may not yet be synchronized among different users. Third, users may originate from different parts of the world. Therefore, the user-friendly name may need to support characters from other alphabets, such as Arabic. The embodiments disclosed herein satisfy these criteria with minimal modifications to the OMA CPM 2.0 specifications. The term “friendly name” will be used herein to refer to a user-friendly name, tag, or label that meets the above criteria and that is assigned to a CPM Conversation History in order to represent the corresponding CPM Conversation History on a user interface in a manner that is meaningful to a human user.

In an embodiment, the Participating Function (PF) generates a user-friendly representation that is used as the initial value for the friendly name to be associated with a conversation. The PF establishes and maintains a mapping between the friendly name and the Conversation-ID when the conversation is recorded into the Message Storage Server.

The initial value for the friendly name may be based on a numbering scheme (e.g., “Conversation 1”. “Conversation 2”, etc.), may be based on the Initiator of the chat and a number (e.g., “Jessie 1”, “Jessie 2”, etc.), may be enhanced with a date/time portion (e “Jessie 22 May 2013, 12:30), may be the first line of the first message, may be the subject in the session information object, or may be any combination of information that the PF can extract or generate based on the contents of the Conversation History or the storage itself. In order to ensure support for international characters, the friendly name may be encoded using a versatile encoding mechanism which supports multi-byte character sets, such as UTF-8.

In an alternative embodiment, instead of the PF, the CPM client may generate and assign the initial friendly name when a CPM Conversation History without a friendly name is encountered. The CPM client may generate and assign the friendly name using substantially the same mechanism described above for a PF generated friendly name. In an embodiment, client-generated friendly names may be considered as a “backup” solution due to drawbacks that may be associated with such a solution. For example, if client-generated friendly names are used, a race condition may occur, and a determination may need to be made regarding which device is allowed to name the folder first. In addition, inconsistent naming conventions may arise when client-generated friendly names are used. That is, different devices may generate different friendly names for the same CPM conversation. Further, extra processing power, and possibly network traffic, may be needed for a client to scrape the Message Storage Server for information that can be used to generate a friendly name.

In another alternative embodiment, when a CPM Conversation History without a friendly name is encountered, other functional components or entities instead of the PF or the CPM client, may generate and assign the initial friendly name. These functional components may be current or future functional components of the OMA CPM Enabler—such as the Message Storage Client, the Controlling Function, or an external entity, i.e., people, such as the end user, or additional functionality, such as devices/servers tapping into the CPM system processes may generate and assign the initial friendly name when a CPM Conversation History without a friendly name is encountered. These other functional components of the OMA CPM Enabler or the external entities may generate and assign the friendly name using substantially the same mechanism described above for a PF-generated friendly name. In an embodiment, friendly names generated by other components of the OMA CPM Enabler or by an external entity may be considered a “last resort” solution.

More specifically, in an embodiment, the Internet Message Access Protocol (IMAP) METADATA extension as defined in RFC5464 may be utilized to store the friendly name as a mailbox annotation for the corresponding Conversation History folder. The metadata entry may be any of the registered mailbox entries (e.g., /private/comment, /shared/comment, etc.) or may be a newly defined entry (e.g., /shared/OMNA/OMACPM20/ConversationLabel, /private/OMNA/OMACPM20/FriendlyName, etc.). In order to avoid additional registrations, it may be preferable, to use one of the existing registrations, namely /shared/comment. There are at least two reasons for using the ‘shared’ registration instead of the ‘private’ registration. First, an owner, a delegate, or any other entity accessing the mailbox should see the same friendly name. Second, when the folder is copied or moved elsewhere, the appropriate friendly name may also be copied, regardless of who is requesting the copy or move operation. In some embodiments, after the initial value for the friendly name has been generated, the user may be avowed to change the initial value to another value. A change of the friendly name on one device may be synchronized onto other devices of the same user through the Message Storage Server.

In an embodiment, friendly names may be free-form UTF-strings. However, friendly names may contain characters from a wide variety of alphabets, as Latin, Hebrew, Cyrillic, Canadian Syllabic, or Old Hungarian. Consequently, an appropriate encoding mechanism, such as UTF-8, UTF-16, or UTF-32, may be used. RFC5464 may not be fully capable of dealing with special characters since such characters may break the syntax of the METADATA command. Therefore, in an embodiment, the Unicode byte representation of the characters may be encoded using an additional level of encoding, such as Base64, UUEncoding, or Bin Hex.

A device is typically configured to display characters in a character set that is likely to be recognizable to the user of the device. For example, a device used by a speaker of Chinese may be configured to display Chinese characters, while a device used by a speaker of Russian may be configured to display Cyrillic characters. The character set typically displayed by a device may be referred to as the device's native character set, and the language represented by the native character set may be referred to as the device's native language.

In an embodiment the friendly name may consist of characters in a device's native character set. In addition, the friendly name may consist of a string of such characters, where the string is likely to be considered a meaningful expression in the device's native language. For instance, the character string “f81d4fae-7dec-11d0-a765-00a0c91e6bf6” would not be considered meaningful to most speakers of English, but the string “Conversation123” would be considered meaningful to most English speakers. The term “meaningful expression” may appear to be subjective, since even a random string of characters may have some meaning to someone or may form one or more words by chance. However, as used herein, the term “meaningful expression” may refer to a string of characters that is likely to be recognized by a typical speaker of a particular languages one or more intentionally formed words, names, or abbreviations.

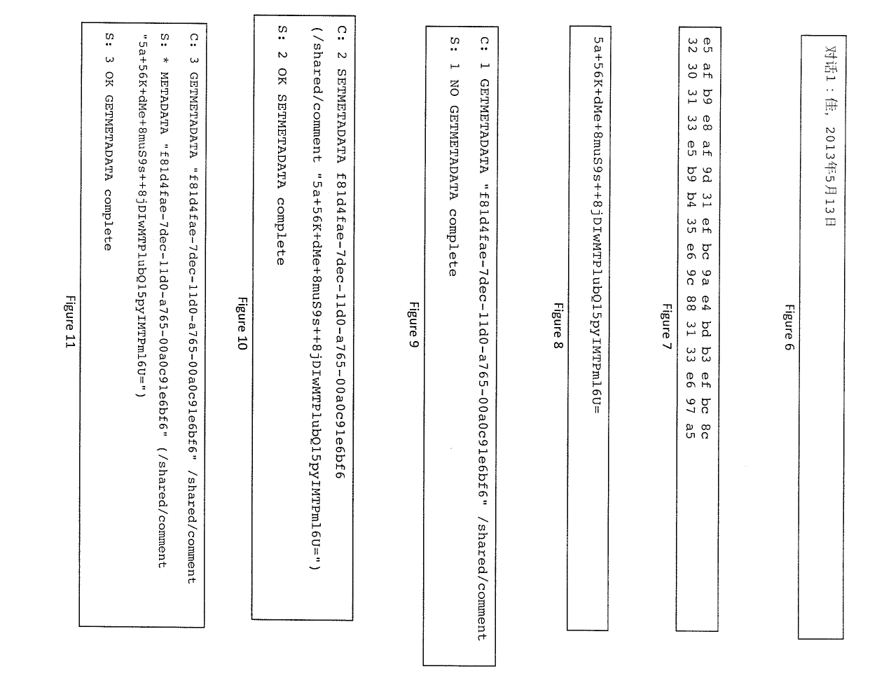

As an example, if the generated string is as shown in FIG. 6, then the string's UTF-8 byte representation using hexadecimal numbers (32 bytes total, 16 bytes per row) may be as shown in FIG. 7. The UTF-8 byte representation after Base64 encoding, 44 characters in total, is shown in FIG. 8. The final Base64-encoded UTF-8 representation, shown in FIG. 8, is suitable for insertion as a mailbox annotation.

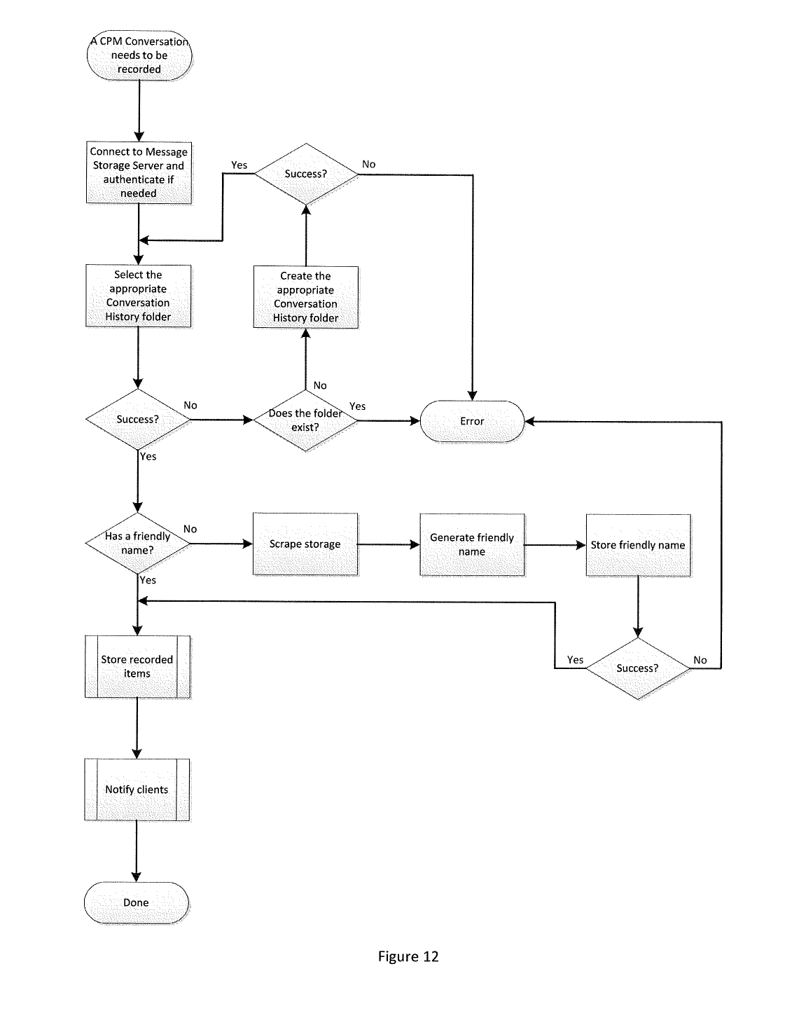

In an embodiment, when conversation items are due for storing, a check is performed to determine whether the CPM Conversation History folder already exists. If the CPM Conversation History folder already exists, the folder may or may not have a friendly name so, in an embodiment, a check is performed to determine whether a friendly name exists, as shown FIG. 9. The ‘NO’ response FIG. 9 indicates that there was an error accessing the metadata entry. A ‘shared’ metadata entry should be available for everyone that has access to the mailbox, so the ‘NO’ response means that the metadata entry does not exist. On the other hand, if the CPM Conversation History folder does not exist, the friendly name will surely not exist either, and consequently, the friendly name may be stored directly, immediately after the CPM Conversation History folder was created. FIG. 10 shows an example of storing a friendly name in the folder metadata. A possible logical flow of these steps is included in FIG. 12.

It may be noted that ‘C’ and ‘S’ in the examples on FIGS. 9, 10, and 11 are commands issued by an IMAP client or an IMAP server, respectively. It may also be noted that from the IMAP server's perspective, all functional components accessing the IMAP server, including the PF, may be seen as IMAP clients. In some embodiments, PFs may be configured to access the IMAP server by other, non-standard means, i.e. through an interface other than CPM-MSG.

Stored metadata, when it exists, may be retrieved by any other functional component, as shown in FIG. 11.

FIG. 12 illustrates steps that may be taken when the friendly name is generated and stored by the PF. Some of the steps in FIG. 12 may be omitted or exchanged or even other steps may be added, depending on how the PF is implemented. In general, before the PF attempts to record one or more items, the PF ensures that the destination folder (the corresponding Conversation History folder) in fact exists. It may be noted that the Conversation History folder may be deleted at any point of time. The PF then checks whether the destination folder already has a friendly name. If the destination folder does not have a friendly name, the PF generates and assigns a friendly name. The PF then stores all items and notifies clients as needed.

FIG. 12 omits steps that may be taken to delay updates from competing clients in order to resolve various race conditions. Server implementations typically queue transactions and lock resources, so in practice, the transactions for two competing requests would be performed one after the other with a negligible delay, until the other transaction that is in progress is complete and the resulting changes will have been committed into the storage, thus resolving the race condition. After both updates are done, the endpoints may be notified about the other transaction that took place and trigger synchronization mechanism to discover the change from the other endpoint.

As mentioned earlier, in some embodiments, a CPM client rather than the PF may generate a friendly name. That is, if the CPM client encounters a CPM Conversation History without a friendly name, such as during synchronization or direct storage access, the CPM client may generate and store a new friendly name in substantially the same manner that the PF does. In order to mitigate possible race conditions in such cases, the service provider may send notifications that trigger synchronization to CPM clients with delays or may use other techniques to prevent a client from updating a friendly name immediately after another client has updated the same friendly name. As examples, there may be a predefined delay between each notification, or when a predefined period after the first notification has passed, all remaining notifications may be sent at once, or one notification may be sent and other notifications may not be sent until the current client disconnects, or all notifications may be sent at once but the other clients may not be allowed in until the first update is successfully completed. Other methods for mitigating race conditions may be apparent to one of skill in the art.

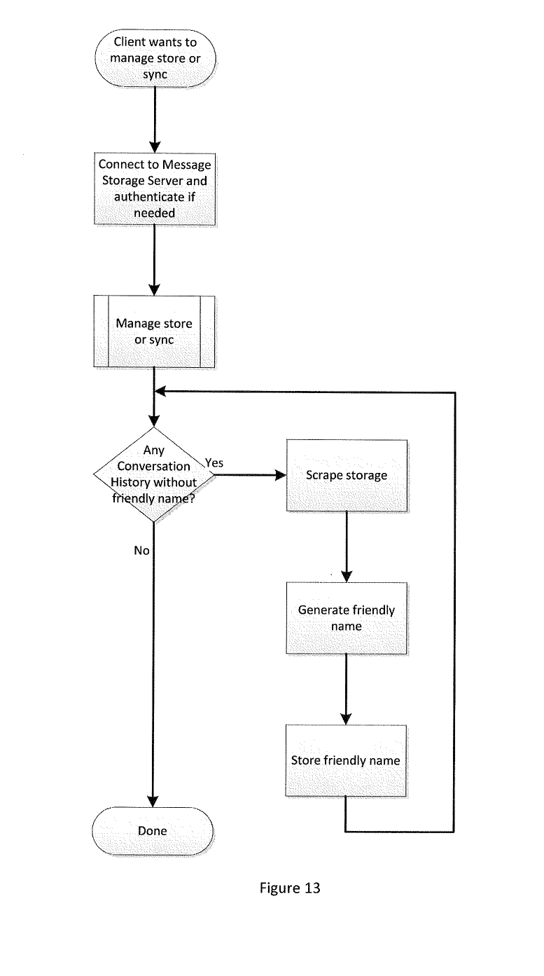

FIG. 13 illustrates steps that may be taken when the friendly name is generated and stored by a CPM client. The CPM client flow shown in FIG. 13 differs from the flow in FIG. 12 in that the CPM client typically does not store new items. Rather, the CPM client typically manages or synchronizes items that are already stored, where management may refer to moving or removing items.

In practice, there is no limitation within the OMA CPM Enabler regarding who can access and manage the Message Storage Server. That is, any functional component internal or external to the system that was successfully authorized can access and manage the storage on behalf of the user, including the service provider or the system itself. Thus, in an embodiment, the friendly name may be generated and assigned by the storage itself, by a dedicated functional component, or, lacking other alternatives, by the user. Regardless of the entity that generates the friendly name, the friendly name that is generated may be stored as a mailbox annotation for the corresponding CPM Conversation History folder, as described above.

The embodiments disclosed herein may not entail any changes in existing end-to-end communication protocols. That is, the existing protocols may continue to use the Conversation-ID to uniquely identify a conversation, and therefore no additional complexity is introduced in end-to-end communications, and in turn no additional complexity is introduced in inter-working towards other systems or networks.

Storage of the friendly name in a central location implies that all devices belonging to the same user will eventually synchronize with the storage server and use the same friendly name to represent a CPM Conversation History on theft user interfaces. Central storage further implies, by the way of storing friendly name in each user's own storage, that different users may use different friendly names for the same CPM Conversation History. In addition, another user (e.g., a support technician) accessing a user's storage may use the same friendly name as the user, so when the other user references a CPM Conversation History while, for example, trying to resolve a technical problem, there is no conflict. Both users (e.g. the support technician and the end-user) may see and be able to refer to the same friendly name.

Generation of a user-friendly name at a single point, such as the PF, implies that the same algorithm yields a consistent naming scheme, that there is no race condition to set the initial friendly name, and that there is no need for a client to consume resources to generate friendly names.

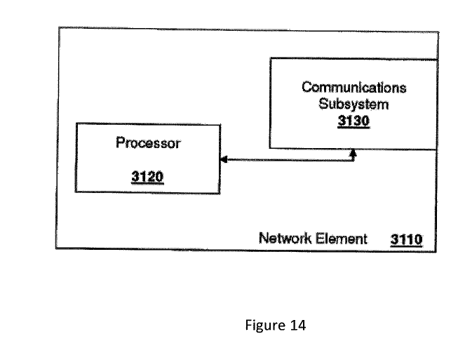

The concepts described above may be implemented by a network element, such as an OMA PF. A simplified network element is shown with regard to FIG. 14. In FIG. 14, network element 3110 includes a processor 3120 and a communications subsystem 3130, where the processor 3120 and communications subsystem 3130 cooperate to perform the methods described above.

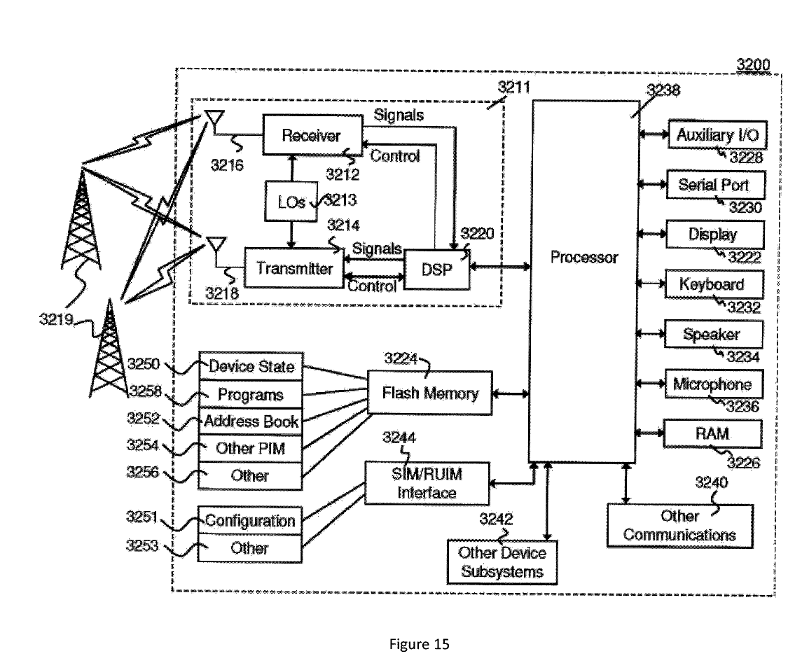

Further, the above may be implemented by a UE. One exemplary device is described below with regard to FIG. 15. UE 3200 is typically a two-way wireless communication device having voice and data communication capabilities. UE 3200 generally has the capability to communicate with other computer systems on the Internet or other networks. Depending on the exact functionality provided, the UE may be referred to as a data messaging device, a two-way pager, a wireless e-mail device, a cellular telephone with data messaging capabilities, a wireless Internet appliance, a wireless device, a mobile device, or a data communication device, as examples.

Where UE 3200 is enabled for two-way communication, it may incorporate a communication subsystem 3211, including a receiver 3212 and a transmitter 3214, as well as associated components such as one or more antenna elements 3216 and 3218, local oscillators (LOs) 3213, and a processing module such as a digital signal processor (DSP) 3220. As will be apparent to those skilled in the field of communications, the particular design of the communication subsystem 3211 will be dependent upon the communication network in which the device is intended to operate.

Network access requirements will also vary depending upon the type of network 3219. In some networks network access is associated with a subscriber or user of UE 3200. A UE may require a removable user identity module (RUIM) or a subscriber identity module (SIM) card in order to operate on a network. The SIM/RUIM interface 3244 is normally similar to a card-slot into which a SIM/RUIM card can be inserted and ejected. The SIM/RUIM card can have memory and hold many key configurations 3251, and other information 3253 such as identification, and subscriber related information.

When required network registration or activation procedures have been completed, UE 3200 may send and receive communication signals over the network 3219. As illustrated, network 3219 can consist of multiple base stations communicating with the UE.

Signals received by antenna 3216 through communication network 3219 are input to receiver 3212, which may perform such common receiver functions as signal amplification, frequency down conversion, filtering, channel selection and the like. Analog to digital (A/D) conversion of a received signal allows more complex communication functions such as demodulation and decoding to be performed in the DSP 3220. In a similar manner, signals to be transmitted are processed, including modulation and encoding for example, by DSP 3220 and input to transmitter 3214 for digital to analog (D/A) conversion, frequency up conversion, filtering, amplification and transmission over the communication network 3219 via antenna 3218. DSP 3220 not only processes communication signals, but also provides for receiver and transmitter control. For example, the gains applied to communication signals in receiver 3212 and transmitter 3214 may be adaptively controlled through automatic gain control algorithms implemented in DSP 3220.

UE 3200 generally includes a processor 3238 which controls the overall operation of the device. Communication functions, including data and voice communications, are performed through communication subsystem 3211. Processor 3238 also interacts with further device subsystems such as the display 3222, flash memory 3224, random access memory (RAM) 3226, auxiliary input/output (I/O) subsystems 3228, serial port 3230, one or more keyboards or keypads 3232, speaker 3234, microphone 3236, other communication subsystem 3240 such as a short-range communications subsystem and any other device subsystems generally designated as 3242. Serial port 3230 can include a USB port or other port known to those in the art.

Some of the subsystems shown in the figure perform communication-related functions, whereas other subsystems may provide “resident” or on-device functions. Notably, some subsystems, such as keyboard 3232 and display 3222, for example, may be used for both communication-related functions, such as entering a text message for transmission over a communication network, and device-resident functions such as a calculator or task list.

Operating system software used by the processor 3238 may be stored in a persistent store such as flash memory 3224, which may instead be a read-only memory (ROM) or similar storage element (not shown). Those skilled in the art will appreciate that the operating system, specific device applications, or parts thereof, may be temporarily loaded into a volatile memory such as RAM 3226. Received communication signals may also be stored in RAM 3226.

As shown, flash memory 3224 can be segregated into different areas for both computer programs 3258 and program data storage 3250, 3252, 3254 and 3256. These different storage types indicate that each program can allocate a portion of flash memory 3224 for their own data storage requirements. Processor 3238, in addition to its operating system functions, may enable execution of software applications on the UE. A predetermined set of applications that control basic operations, including at least data and voice communication applications for example, will normally be installed on UE 3200 during manufacturing. Other applications could be installed subsequently or dynamically.

Applications and software may be stored on any computer readable storage medium. The computer readable storage medium may be a tangible or in transitory/non-transitory medium such as optical (e.g., CD, DVD, etc.), magnetic (e.g., tape) or other memory known in the art.

One software application may be a personal information manager (PIM) application having the ability to organize and manage data items relating to the user of the UE such as, but not limited to, e-mail, calendar events, voice mails, appointments, and task items. Naturally, one or more memory stores may be available on the UE to facilitate storage of PIM data items. Such PIM application may have the ability to send and receive data items, via the wireless network 3219. Further applications may also be loaded onto the UE 3200 through the network 3219, an auxiliary I/O subsystem 3228, serial port 3230, short-range communications subsystem 3240 or any other suitable subsystem 3242, and installed by a user in the RAM 3226 or a non-volatile store (not shown) for execution by the processor 3238. Such flexibility in application installation increases the functionality of the device and may provide enhanced on-device functions, communication-related functions, or both. For example, secure communication applications may enable electronic commerce functions and other such financial transactions to be performed using the UE 3200.

In a data communication mode, a received signal such as a text message or web page download will be processed by the communication subsystem 3211 and input to the processor 3238, which may further process the received signal for output to the display 3222, or alternatively to an auxiliary I/O device 3228.

A user of UE 3200 may also compose data items such as email messages for example, using the keyboard 3232, which may be a complete alphanumeric keyboard or telephone-type keypad, among others, in conjunction with the display 3222 and possibly an auxiliary I/O device 3228. Such composed items may then be transmitted over a communication network through the communication subsystem 3211.

For voice communications, overall operation of UE 3200 is similar, except that received signals may typically be output to a speaker 3234 and signals for transmission may be generated by a microphone 3236. Alternative voice or audio I/O subsystems, such as a voice message recording subsystem, may also be implemented on UE 3200. Although voice or audio signal output is preferably accomplished primarily through the speaker 3234, display 3222 may also be used to provide an indication of the identity of a calling party, the duration of a voice call, or other voice call related information for example.

Serial port 3230 may normally be implemented in a personal digital assistant (FDA)-type UE for which synchronization with a user's desktop computer (not shown) may be desirable, but is an optional device component. Such a port 3230 may enable a user to set preferences through an external device or software application and may extend the capabilities of UE 3200 by providing for information or software downloads to UE 3200 other than through a wireless communication network. The alternate download path may for example be used to load an encryption key onto the device through a direct and thus reliable and trusted connection to thereby enable secure device communication. As will be appreciated by those skilled in the art, serial port 3230 can further be used to connect the UE to a computer to act as a modem.

Other communications subsystems 3240, such as a short-range communications subsystem, is a further optional component which may provide for communication between UE 3200 and different systems or devices, which need not necessarily be similar devices. For example, the subsystem 3240 may include an infrared device and associated circuits and components or a Bluetooth™ communication module to provide for communication with similarly enabled systems and devices. Subsystem 3240 may further include non-cellular communications such as WiFi or WiMAX.

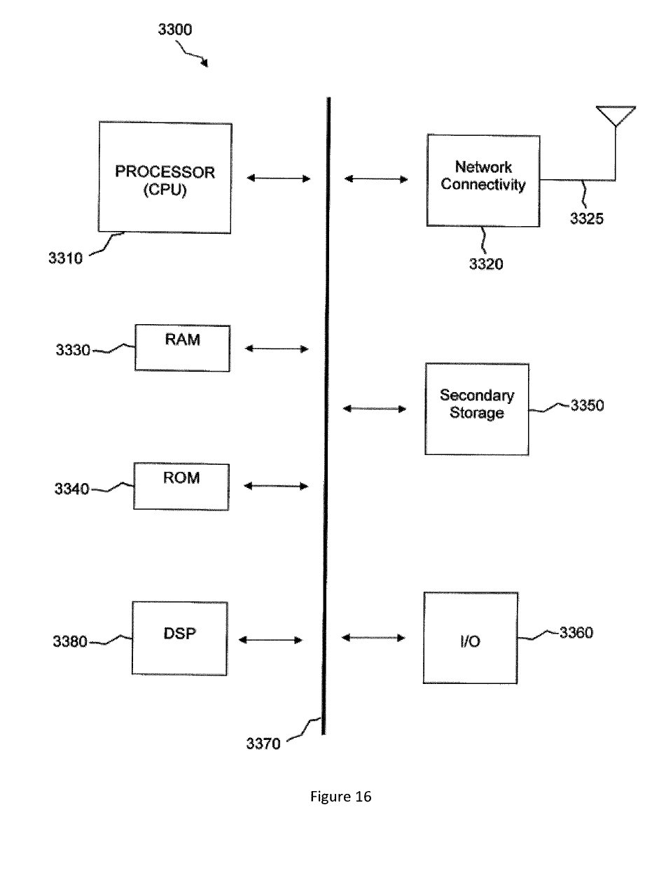

The UE and other components described above might include a processing component that is capable of executing instructions related to the actions described above. FIG. 16 illustrates an example of a system 3300 that includes a processing component 3310 suitable for implementing one or more embodiments disclosed herein. The processing component 3310 may be substantially similar to the processor 3120 of FIG. 14 and/or the processor 3238 of FIG. 15.

In addition to the processor 3310 (which may be referred to as a central processor unit or CPU), the system 3300 might include network connectivity devices 3320, random access memory (RAM) 3330, read only memory (ROM) 3340, secondary storage 3350, and input/output I/O devices 3360. These components might communicate with one another via a bus 3370. In some cases, some of these components may not be present or may be combined in various combinations with one another or with other components not shown. These components might be located in a single physical entity or in more than one physical entity. Any actions described herein as being taken by the processor 3310 might be taken by the processor 3310 alone or by the processor 3310 in conjunction with one or more components shown or not shown in the drawing, such as a digital signal processor (DSP) 3380. Although the DSP 3380 is shown as a separate component, the DSP 3380 might be incorporated into the processor 3310.

The processor 3310 executes instructions, codes, computer programs, or scripts that it might access from the network connectivity devices 3320, RAM 3330, ROM 3340, or secondary storage 3350 (which might include various disk-based systems such as hard disk, floppy disk, or optical disk). While only one CPU 3310 is shown, multiple processors may be present. Thus, while instructions may be discussed as being executed by a processor, the instructions may be executed simultaneously, serially, or otherwise by one or multiple processors. The processor 3310 may be implemented as one or more CPU chips.

The network connectivity devices 3320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (COMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. These network connectivity devices 3320 may enable the processor 3310 to communicate with the Internet or one or more telecommunications networks or other networks from which the processor 3310 might receive information or to which the processor 3310 might output information. The network connectivity devices 3320 might also include one or more transceiver components 3325 capable of transmitting and/or receiving data wirelessly.

The RAM 3330 might be used to store volatile data and perhaps to store instructions that are executed by the processor 3310. The ROM 3340 is a non-volatile memory device that typically has a smaller memory capacity than the memory capacity of the secondary storage 3350. ROM 3340 might be used to store instructions and perhaps data that are read during execution of the instructions. Access to both RAM 3330 and ROM 3340 is typically faster than to secondary storage 3350. The secondary storage 3350 is typically comprised of one or more disk drives or tape drives and might be used for non-volatile storage of data or as an over-flow data storage device if RAM 3330 is not large enough to hold all working data. Secondary storage 3350 may be used to store programs that are loaded into RAM 3330 when such programs are selected for execution.

The I/O devices 3360 may include liquid crystal displays (LCDs), touch screen displays, keyboards, keypads, switches, dials, mice, track balls, voice recognizers, card readers, paper tape readers, printers, video monitors, or other wed-known input/output devices. Also, the transceiver 3325 might be considered to be a component of the I/O devices 3360 instead of or in addition to being a component of the network connectivity devices 3320.

In an embodiment, a method for identifying a conversation that occurs according to an OMA CPM protocol is provided. The method comprises generating a friendly name for the conversation, wherein the friendly name comprises a string of characters that form a meaningful expression in a native language of a device on which the conversation occurs, and associating the friendly name with the conversation.

In another embodiment, an OMA CPM PF is provided. The PF comprises a processor configured such that the PF generates a friendly name for a CPM-based conversation, wherein the friendly name comprises a string of characters that form a meaningful expression in a native language of a device on which the conversation occurs. The processor is further configured such that the PF associates the friendly name with the conversation.

In another embodiment, an OMA CPM client is provided. The client comprises a processor configured such that the client generates a friendly name for a CPM-based conversation wherein the friendly name comprises a string of characters that form a meaningful expression in a native language of a device on which the conversation occurs. The processor is further configured such that the client associates the friendly name with the conversation.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for identifying a conversation that occurs according to an Open Mobile Alliance (OMA) Converged IP (Internet Protocol) Messaging (CPM) protocol, the method comprising:
generating a friendly name for the conversation, wherein the friendly name comprises a string of characters that form a meaningful expression to a conversation participant; and
associating the friendly name with the conversation.

2. The method of claim 1, wherein the friendly name is generated by an OMA Participating Function (PF).

3. The method of claim 2, wherein the PF generates the friendly name based on information extracted from a CPM Conversation History.

4. The method of claim 2, wherein the PF maps the friendly name to an OMA Conversation-ID when the conversation is recorded into an OMA Message Storage Server.

5. The method of claim 4, wherein, before the PF attempts to record the conversation, the PF determines whether a CPM Conversation History folder associated with the conversation exists and whether the CPM Conversation History folder has a friendly name, and wherein, when the CPM Conversation History folder does not have a friendly name, the PF generates a friendly name and assigns the friendly name to the CPM Conversation History folder.

6. The method of claim 1, wherein the friendly name is generated by one of:
a CPM client;
a functional component of the OMA CPM Enabler other than the PF; and
an entity external to OMA CPM protocols.

7. The method of claim 6, wherein the friendly name is generated by the CPM client when the CPM client encounters a CPM Conversation History without a friendly name, and wherein the CPM client takes measures to ensure that a race condition does not occur in the generation of the friendly name.

8. The method of claim 1, wherein the friendly name is stored as a mailbox extension for a corresponding CPM Conversation History folder via the use of an Internet Message Access Protocol (IMAP) metadata extension.

9. The method of claim 8, wherein the metadata extension is one of:
a registered mailbox entry; and
a newly defined mailbox entry.

10. The method of claim 9, wherein, when the metadata extension is a registered mailbox entry, the metadata extension is the /shared/comment registration.

11. The method of claim 1, wherein all devices of a single user use the same friendly name for the same conversation.

12. The method of claim 11, wherein the user is allowed to modify the friendly name, and wherein, responsive to the modification, all of the user's devices are synchronized with modified friendly name.

13. An Open Mobile Alliance (OMA) Converged IP (Internet Protocol) Messaging (CPM) Participating Function (PF), the PF comprising:
a processor configured such that the PF generates a friendly name for a CPM based conversation, wherein the friendly name comprises a string of characters that form a meaningful expression to a conversation participant, and the processor further configured such that the PF associates the friendly name with the conversation.

14. The PF of claim 13, wherein the PF generates the friendly name based on information extracted from a CPM Conversation History.

15. The PF of claim 13, wherein the PF maps the friendly name to an OMA Conversation-ID when the conversation is recorded into an OMA Message Storage Server.

16. The PF of claim 15, wherein, before the PF attempts to record the conversation, the PF determines whether a CPM Conversation History folder associated with the conversation exists and whether the CPM Conversation History folder has a friendly name, and wherein, when the CPM Conversation History folder does not have a friendly name, the PF generates a friendly name and assigns the friendly name to the CPM Conversation History folder.

17. The PF of claim 13, wherein the friendly name is stored as a mailbox extension for a corresponding CPM Conversation History folder via the use of an Internet Message Access Protocol (IMAP) metadata extension.

18. The PF of claim 17, wherein the metadata extension is one of:
a registered mailbox entry; or
a newly defined mailbox entry,
and wherein, when the metadata extension is a registered mailbox entry, the metadata extension is the /shared/comment registration.

19. An Open Mobile Alliance (OMA) Converged IP (Internet Protocol) Messaging (CPM) client, the client comprising:
a processor configured such that the client generates a friendly name for a CPM-based conversation, wherein the friendly name comprises a string of characters that form a meaningful expression to a conversation participant, and the processor further configured such that the client associates the friendly name with the conversation.

20. The client of claim 19, wherein the friendly name is generated by the client when the client encounters a CPM Conversation History without a friendly name, and wherein the client takes measures to ensure that a race condition does not occur in the generation of the friendly name.
